(19) United States
(12) Patent Application Publication
(10) Pub. No.: US 2006/0115642 A1
(43) Pub. Date: Jun. 1, 2006

(54) Preparations for use in concrete

(76) Inventors: Rudiger Musch, Bergisch Gladbach (DE); Horst Stepanski, Leverkusen (DE); Stefan Bohm, Schwilper (DE); Klaus Dilger, Braunschweig (DE); Frank Mund, Dusseldorf (DE)

Correspondence Address: BAYER MATERIAL SCIENCE LLC, 100 BAYER ROAD, PITTSBURGH, PA, 15205, US

(21) Appl. No.: 11/257,188

(22) Filed: Oct. 24, 2005

(30) Foreign Application Priority Data
Oct. 27, 2004 (DE) 1020040521700

(51) Int. Cl. B32B 13/02

(52) U.S. Cl. 428/294.7

(57) ABSTRACT

The present invention provides a process for finishing fibrous products with a preparation based on aqueous dispersions of polychloroprene and a process for preparing textile-reinforced and fiber-reinforced concrete and other cement-based products including those finished products.

### FIELD OF THE INVENTION

The invention relates to a process for preparing fibrous products finished with aqueous dispersions of polychloroprene and a process for preparing textile-reinforced and fiber-reinforced concrete and other cement-based products including the finished fibrous products.

### BACKGROUND OF THE INVENTION

Concrete is one of the most important materials used in the construction industry and offers several advantages. It is inexpensive, durable and flexible with regard to design and mode of production. Accordingly, there are many different applications of concrete which lie in both the static/structural area and also in the non-load-bearing area.

Concrete offers a particularly advantageous cost-benefit ratio for the transfer of compressive forces and is thus used to a large extent in the construction industry.

Due to concrete's low tensile strength, reinforcement is required for the take-up of tensile forces and this reinforcement usually is in the form of steel. To ensure a good bond and as an anticorrosion measure, concrete steel reinforcement is typically provided with a concrete covering which is at least 2-3 cm thick. This leads to components with a thickness of at least 4-6 cm, depending on the environmental conditions and the method of preparation. If corrosion-insensitive, non-metallic, materials are used as reinforcement materials, then, as is well-known, filigree and thin-walled cross-sections can be achieved due to the thin covering of concrete required.

Short fibers, for example, may be added to reinforce thin-walled concrete work pieces. At present, short fibers typically are used, but the length and orientation of these fibers are not clearly defined in the composite material. Currently, the area of application for short fiber reinforced concretes is restricted to components subjected to low mechanical stresses such as, for example, floor screeds and objects such as plant tubs, etc.

Long fibers exhibit greater effectiveness in thin-walled concrete work pieces and these can be arranged in the direction of the tensile stresses occurring, for example in the form of rovings or textiles.

To develop both more demanding and new types of fields of application for the fiber-concrete method of construction, industrial textiles with reinforcement filaments aligned in the direction of the highest tensile stresses have been developed. Industrial textiles (two-dimensional or multi-dimensional) such as non-woven fabrics, netting, knitted fabrics or molded knitted fabrics are currently used only in individual cases during the industrial production of textile-reinforced concrete components. The reason for this is the current lack of production processes for processing such textiles to form components with complicated geometries. The methods used hitherto for producing textile-reinforced components permit the production of only linear, flat shapes because, in most cases, the dimensional stability of the textile is achieved by stretching. Particularly in the case of complicated geometries, stretching during industrial production is impossible or possible to only a limited extent. At present, it is impossible to insert flexible reinforcement textiles in such components in a reproducible manner.

Steel, plastics and glass fibers are currently used for the reinforcement of cement-bonded building materials. The plastics fibers used are typically polypropylene fibers, but aramid fibers are also used. The table below gives the typical mechanical parameters for a variety of fibers.

| | Density | Tensile strength | E-modulus |
|---|---|---|---|
| Material | [g/cm³] | [GPa] | [GPa] |
| Alkali-resistant AR glass | 2.5-2.7 | 1.7-2.0 | 74 |
| Carbon | 1.6-2.0 | 1.5-3.5 | 180-500 |
| Aramid | 1.44-1.45 | 2.8-2.9 | 59-127 |
| Polypropylene | 1.0 | 0.5-0.75 | 5-18 |

From among the large group of different glasses, virtually the only suitable are so-called AR glass fibers, because of their sufficiently high stability in the highly alkaline environment of cement-bonded building materials.

In the lecture entitled “USE OF ADHESIVES FOR TEXTILE-REINFORCED CONCRETE” by S. Böhm, K. Dilger and F. Mund, 26th Annual Meeting of the Adhesive Society in Myrtle Beach, S.C., USA, Feb. 26th, 2003, it was demonstrated that the calculated yarn tensile strength/load-carrying capacity of reinforcement textiles is not achieved in concrete. The yarn trials described in this publication show that yarn tensile strength can be increased 30-40% by penetration with a polymer phase. This type of penetration was achieved by soaking bundles of fibers (so-called rovings) with various aqueous polymer dispersions, inter alia, those based on polychloroprene, and also with reactive resin formulations based on epoxide resin or unsaturated polyesters.

Three methods are known in the art for the polymer coating and soaking of textile concrete reinforcing fibers:

Method 1: The first method is based on a two-step system. The filaments or rovings are first coated with, or penetrated by, a polymer phase and then embedded in fine concrete. Polymers used for this purpose are aqueous dispersions based on polychloroprene, acrylate, chlorinated rubber, styrene-butadiene or reactive systems based on epoxide resin and those based on unsaturated polyesters. Penetration of the rovings may take place by coating the filaments during production of the rovings or by soaking the rovings before or after textile production. Curing or cross-linking of the polymer phase is performed before introducing the reinforcement textiles into the concrete. The rovings or textiles treated in this way are embedded in fine concrete. To be able to take advantage of the mechanical properties of the fibers, the resin must have extension properties at least as good as the fibers.

Method 2: The second method involves introducing thermoplastic filaments during production of the rovings, these are melted, the filaments are wetted and, after solidification, this leads to an internal adhesive composite material. In this case, friction spun yarns are not used, but thermoplastic filaments are added during production of the yarn.

Method 3: The third method is based on a one-step system. In the case of the one-step system, soaking of the textiles is achieved during the fresh concrete phase, the polymer being added along with the fine concrete.

### SUMMARY OF THE INVENTION

The present invention provides a process for finishing fibrous products with preparations based on aqueous dispersions of polychloroprene and a process for preparing textile-reinforced and fiber-reinforced concrete and other cement-based products containing those finished fibrous products. The present invention improves the properties of the fibrous products used for reinforcement, which have been finished in accordance with Method 1 described hereinabove.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 illustrates the properties of textile-reinforced concrete;

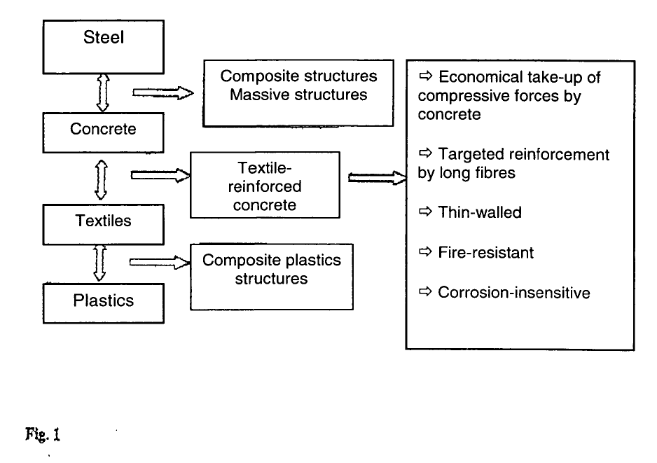

FIG. 2 shows the mold used to prepare the specimen for the pull-out test described hereinbelow; and

FIG. 3 depicts the structure and dimensions of a pull-out specimen and the experimental layout for the pull-out test described hereinbelow.

### DETAILED DESCRIPTION OF THE INVENTION

The present invention will now be described for purposes of illustration and not limitation. Except in the operating examples, or where otherwise indicated, all numbers expressing quantities, percentages and so forth in the specification are to be understood as being modified in all instances by the term “about.”

The present invention provides an improved process for reinforcing one of concrete and cement, the improvement involving including a fibrous product soaked in a preparation made from
(a) 20 to 99 wt. % of an aqueous dispersion based on polychloroprene,
(b) 1 to 80 wt. % of an aqueous suspension based on inorganic solids chosen from oxides, carboxides and silicates,
(c) optionally, polymer dispersions chosen from polyacrylates, polyacetates, polyurethanes, polyureas, rubbers and epoxides, and
(d) optionally, additives and auxiliaries chosen from resins, stabilizers, antioxidants, cross-linking agents, cross-linking accelerators, fillers, thickening agents and fungicides,
   wherein the weight percentages of (a) and (b) total 100 wt. % and are based on the weight of non-volatile fractions.

The present invention further provides a fibrous product soaked with a preparation made from:
(a) 20 to 99 wt. % of an aqueous dispersion based on polychloroprene; and
(b) 1 to 80 wt. % of an aqueous suspension based on inorganic solids chosen from oxides, carboxides and silicates,
(c) optionally, polymer dispersions chosen from polyacrylates, polyacetates, polyurethanes, polyureas, rubbers and epoxides, and
(d) optionally, additives and auxiliaries chosen from resins, stabilizers, antioxidants, cross-linking agents, cross-linking accelerators, fillers, thickening agents and fungicides,
   wherein the weight percentages of (a) and (b) total 100 wt. % and are based on the weight of non-volatile fractions.

The present invention improves the properties of the fibrous products used for reinforcement, which have been finished in accordance with Method 1 described hereinabove. On the basis of its well-known properties, polychloroprene in the form of a strongly alkaline aqueous dispersion appears to be especially suitable, particularly polychloroprene having a high capacity for crystallization.

It is known to those skilled in the art that such a polychloroprene is chemically very stable in an alkaline environment. Thus, this polymer possesses very good prerequisites for use in concrete.

The mechanical properties of textile-reinforced concrete depend on the position of the textile reinforcement. Polychloroprene which is highly crystalline at room temperature enables thorough soaking of the fibers when used in the form of aqueous dispersions. As a result of the crystallinity, the thoroughly soaked textile is stiffened so much after drying that it can be introduced into the shell-mold in rigid form as a geometrically fixed reinforcement.

When heated, the partially crystalline structure is converted into an amorphous state so that a flat textile material may be thermoformed into the desired three-dimensional shape which is then retained in a rigid form after cooling and recrystallization.

The mechanical stresses introduced into the concrete should preferably be distributed as uniformly as possible over the entire yarn cross-section of the textile, with the avoidance of localized stress peaks, and should ensure the highest possible bond between the concrete matrix and the textile when subjected to strain. This is achieved according to the invention by thorough soaking of the textile with the polychloroprene preparation. However, the adhesion of concrete to individual fibers is also intended to be increased to thereby improve the properties of concrete parts which contain admixed individual fibers for reinforcement purposes, e.g. floor screeds.

Therefore, the composition of a polychloroprene dispersion was modified such that the mechanical properties of concrete components reinforced with fibrous products treated with these preparations are substantially enhanced.

Fibrous products, in the context of the present invention, include, but are not limited to fibers, rovings, yarns, textiles, knitted fabrics, bonded fabrics or non-woven fabrics.

The present invention soaks fibrous products in an aqueous alkaline dispersion. Those finished fibrous products are subsequently used to reinforce concrete. The aqueous dispersion contains, apart from polychloroprene, additional inorganic solids, preferably chosen from oxides, carboxides and silicates, more preferably silicon dioxide, preferably in the form of nanoparticles. The effectiveness of the inorganic solids is further increased if the polychloroprene contains a particularly high concentration of hydroxyl groups and gel fractions. The strengths achieve maximum values when, after soaking, drying of the fibrous produces takes place at elevated temperatures, preferably above 20° C., more preferably at temperatures above 100° C., most preferably up to 220° C., particularly where the inorganic solid is zinc oxide.

Therefore, the present invention provides an aqueous preparation containing
(a) a polychloroprene dispersion with an average particle size of 60 to 220 nm, preferably 70 to 160 nm, as well as
(b) an aqueous dispersion of inorganic solids, preferably chosen from oxides, carboxides and silicates, particularly preferably silicon dioxide, preferably with a particle diameter for the particles of 1 to 400 nm, more preferably 5 to 100 nm, most preferably 8 to 50 nm
   for the soaking of fibrous products used in reinforcing concrete.

The polychloroprene dispersion (a) may be obtained by methods known to those skilled in the art, preferably by:
polymerization of chloroprene in the presence of 0-1 mmol of a regulator, with respect to 100 g of monomer, at temperatures of 0° C.-70° C., wherein the dispersion has a proportion of 0-30 wt. % which is insoluble in organic solvents, with respect to the polymers,
removal of the residual unpolymerized monomers by steam distillation
storage of the dispersion at temperatures of 50° C.-110° C., wherein the proportion which is insoluble in organic solvents (gel fraction) rises to 0.1 wt. % to 60 wt. %, increasing the solids content to 50-64 wt. % due to a creaming process.

Following soaking of fibrous products with the preparation, in one embodiment of the invention, cross-linking of the mixture on the substrate takes place after removal of the water at temperatures of 20° C.-220° C.

The preparation of polychloroprene has been well-known for a long time and may preferably be performed by emulsion polymerization in alkaline aqueous media: See “Ullmanns Encyclopädie der technischen Chemie”, vol. 9, p. 366, Verlag Urban und Schwarzenberg, Munich-Berlin, 1957; “Encyclopedia of Polymer Science and Technology”, vol. 3, p. 705-730, John Wiley, New York, 1965; “Methoden der Organischen Chemie” (Houben-Weyl) XIV/1, 738 ff. Georg Thieme Verlag Stuttgart 1961.

Suitable emulsifiers include all compounds and mixtures thereof which stabilize the emulsion to an adequate degree, such as e.g. water-soluble salts, in particular sodium, potassium and ammonium salts of long-chain fatty acids, colophony and colophony derivatives, high molecular weight alcohol sulfates, aryl sulfonic acids, formaldehyde condensates of aryl sulfonic acids, non-ionic emulsifiers based on polyethylene oxide and polypropylene oxide and polymers which act as emulsifiers such as polyvinyl alcohol (DE-A 2 307 811, DE-A 2 426 012, DE-A 2 514 666, DE-A 2 527 320, DE-A 2 755 074, DE-A 3 246 748, DE-A 1 271 405, DE-A 1 301 502, U.S. Pat. No. 2,234,215, JP-A 60-31 510).

Suitable polychloroprene dispersions according to the invention may be prepared by emulsion polymerization of chloroprene and an ethylenically unsaturated monomer which is copolymerizable with chloroprene, in alkaline medium. Polychloroprene dispersions which are prepared by continuous polymerization are particularly preferred, such as are described e.g. in WO-A 02/24825, example 2 and DE 3 002 734, example 6, wherein the regulator content can be varied between 0.01% and 0.3%.

The chain transfer agents preferred for adjusting the viscosity are e.g. mercaptans.

Particularly preferred chain transfer agents include n-dodecylmercaptan and the xanthate disulfides used in accordance with DE-A 3 044 811, DE-A 2 306 610 and DE-A 2 156 453.

After polymerization the residual chloroprene monomers may be removed by steam distillation. This may be performed as described in e.g. “W. Obrecht in Houben-Weyl: Methoden der organischen Chemie vol. 20, part 3, Makromolekulare Stoffe, (1987), p. 852”.

In another embodiment of the present invention, the low-monomer polychloroprene dispersion prepared is stored at elevated temperatures. Thus, once some of the labile chlorine atoms have been removed, a polychloroprene network is built up which is not soluble in organic solvents (a gel).

In a further step, the solids content of the dispersion may preferably be increased by a creaming process. This creaming may be performed e.g. by the addition of alginates as described in “Neoprene Latices, John C. Carl, E.I. Du Pont 1964, p. 13” or EP-A 1 293 516.

Aqueous dispersions of inorganic solids, preferably chosen from oxides, carboxides and silicates, more preferably silicon dioxide, are known to those skilled in the art and may have a variety of structures, depending on the method of preparation.

Suitable silicon dioxide dispersions useful in the present invention may be obtained on the basis of silica sols, silica gels, pyrogenic silicas or precipitated silicas or mixtures thereof.

According to the invention, those aqueous dispersions of inorganic solids are preferably used in which the particles have a primary particle size of 1 to 400 nm, more preferably 5 to 100 nm and most preferably 8 to 50 nm. Preferably, the particle sizes of the inorganic solids are adjusted to the desired size by milling, this applying in particular to precipitated silicas. Preferred preparations according to the invention are those in which the particles of inorganic solids, e.g. the SiO₂ particles in a silicon dioxide dispersion b), are present as discrete, non-cross-linked primary particles. It is also preferred that the particles have hydroxyl groups available at the surface of the particles. Aqueous silica sols are particularly preferably used as aqueous dispersions of inorganic solids. Silicon dioxide dispersions which useful in the invention are disclosed in WO 03/102066.

An essential property of the dispersions of inorganic solids used in the invention is that they do not act as thickeners, or do so only to a very slight extent, in the formulations, even with the addition of water-soluble salts (electrolytes) or substances which can partially go into solution and increase the electrolyte content of the dispersion, such as e.g. zinc oxide. The thickening effect of the inorganic solids in formulations of polychloroprene dispersions preferably should not exceed 2000 mPas, more preferably 1000 mPas. That applies in particular to silicas.

To prepare the preparation according to the invention, the ratios by weight of the individual components are preferably chosen so that the resulting dispersion has a concentration of dispersed polymers of 30 to 60 wt. %, wherein the proportion of polychloroprene (a) is 20 to 99 wt. % and that of the dispersion of inorganic solids (b) is 1 to 80 wt. %, wherein the percentages refer to the weight of non-volatile fractions and add up to 100 wt. %.

Preparations according to the invention more preferably contain a proportion of 70 wt. % to 98 wt. % of polychloroprene dispersion (a) and a proportion of 2 wt. % to 30 wt. % of a dispersion of inorganic solids (b), wherein the percentages refer to the weight of non-volatile fractions and add up to 100 wt. %.

Polychloroprene dispersions (a) may optionally also contain other dispersions such as e.g. polyacrylate, polyvinylidene chloride, polybutadiene, polyvinyl acetate or styrene-butadiene dispersions, in a proportion of up to 30 wt. %, with respect to the entire dispersion (a).

Dispersions (a) and/or (b) used according to the invention or the entire preparation may optionally contain further additives and auxiliary agents which are known from adhesive and dispersion technology, e.g. resins, stabilizers, antioxidants, cross-linking agents and cross-linking accelerators. For example, fillers such as quartz flour, quartz sand, barites, calcium carbonate, chalk, dolomite or talcum, optionally together with cross-linking agents, for example polyphosphates such as sodium hexametaphosphate, naphthalinesulfonic acid, ammonium or sodium polyacrylic acid salts, may be added, wherein the fillers are preferably added in amounts of 10 to 60 wt. %, more preferably 20 to 50 wt. % and the cross-linking agents are preferably added in amounts of 0.2 to 0.6 wt. %, all weight percentages with respect to the non-volatile fractions.

Other suitable auxiliary agents such as for example organic thickening agents such as cellulose derivatives, alginates, starch, starch derivatives, polyurethane thickening agents or polyacrylic acids may preferably be added in amounts of 0.01 to 1 wt. %, with respect to non-volatile fractions, or inorganic thickening agents such as for example bentonites preferably in amounts of 0.05 to 5 wt. %, with respect to non-volatile fractions, may be added to dispersions (a) or (b) or the entire preparation, wherein the thickening effect in the formulation should preferably not exceed 1000 mPas.

For preservation purposes, fungicides may also be added to compositions according to the invention. These may preferably be used in amounts of 0.02 to 1 wt. %, with respect to non-volatile fractions. Suitable fungicides are for example phenol and cresol derivatives or tin inorganic compounds or azol derivatives such as TEBUCONAZOL or KETOCONAZOL.

Tackifying resins such as e.g. unmodified or modified natural resins such as colophony esters, hydrocarbon resins or synthetic resins such as phthalate resins may also optionally be added to compositions according to the invention or to the components used for preparing these in dispersed form (see e.g. in “Klebharze” R. Jordan, R. Hinterwaldner, p. 75-115, Hinterwaldner Verlag, Munich, 1994). Alkyl phenol resin and terpene phenol resin dispersions with softening points preferably higher than 70° C., more preferably higher than 110° C., are preferred.

It is also possible to use organic solvents such as for example toluene, xylene, butyl acetate, methylethyl ketone, ethyl acetate, dioxan or mixtures of these, or softeners such as for example those based on adipates, phthalates or phosphates, in amounts of 0.5 to 10 wt. %, with respect to non-volatile fractions.

Preparations to be used according to the invention are prepared by mixing polychloroprene dispersion (a) with the dispersion of inorganic solids (b) and optionally adding conventional auxiliary agents and additives to the mixture obtained or to both dispersions or to the individual components.

A preferred process for preparing preparations to be used according to the invention is characterized in that polychloroprene dispersion (a) is first mixed with the auxiliary agents and additives and a dispersion of inorganic solids (b) is added during or after the mixing procedure.

The polychloroprene preparations may be applied in any manner, e.g. by brushing, pouring, spraying or immersing. Drying the film produced may take place at room temperature or at elevated temperatures up to 220° C.

Preparations to be used according to the invention may also be used as adhesives, for example to bond any substrates of the same or different type. The adhesive layer may then be cross-linked on or in the substrates of this type obtained. The substrates obtained in this way may optionally be used for the strengthening (reinforcement) of concrete.

### EXAMPLES

Preparation of Polychloroprene Dispersions

Polymerization of the chloroprene or polychloroprene dispersion takes place using a continuous process, as is described in EP-A 0 032 977.

### Example 1

The aqueous phase (W) and the monomer phase (M) were passed via a measurement and control apparatus into the first reactor of a polymerization cascade made from 7 identical reactors, each with a volume of 50 liters, in a permanently constant ratio by weight, along with the activator phase (A). The average residence time per tank was 25 minutes. The reactors correspond to those described in DE-A 2 650 714 (data in parts by wt. per 100 g parts by wt. of monomers used).

(M)=Monomer Phase:

| | | |
|---|---|---|
| chloroprene | 100.0 | parts by wt. |
| n-dodecylmercaptan | 0.11 | parts by wt. |
| phenothiazine | 0.005 | parts by wt. |

(W)=Aqueous Phase:

| | | |
|---|---|---|
| deionized water | 115.0 | parts by wt. |
| sodium salt of disproportionated abietic acid | 2.6 | parts by wt. |
| potassium hydroxide | 1.0 | parts by wt. |

(A)=Activator Phase:

| | | |
|---|---|---|
| 1% aqueous formamidinesulfinic acid solution | 0.05 | parts by wt. |
| potassium persulfate | 0.05 | parts by wt. |
| Na salt of anthraquinone-2-sulfonic acid | 0.005 | parts by wt. |

Reaction started up readily at an internal temperature of 15° C. The heat of polymerization released was removed and the polymerization temperature was held at 10° C. by an external cooling system. Reaction was terminated at a monomer conversion of 70% by adding diethylhydroxylamine. The residual monomer was removed from the polymers by steam distillation. The solids content was 33 wt. %, the gel content was 0 wt. % and the pH was 13.

After a polymerization time of 120 hours, the polymerization route was extended.

Then the dispersion prepared as detailed above was creamed in the following manner.

Solid alginate (MANUTEX) was dissolved in deionized water and a 2 wt. % strength alginate solution was prepared. 200 g of the polychloroprene dispersion were initially placed in each of eight 250 ml glass flasks and 6 to 20 g of the alginate solution was stirred into each flask, in 2 g steps. After a storage time of 24 hours, the amount of serum produced above the thick latex was measured. The amount of alginate in the sample with the greatest serum production was multiplied by 5 to arrive at the optimum amount of alginate for creaming 1 kg of polychloroprene dispersion.

### Example 2

The same procedure was used as in Example 1, but the concentration of regulator in the monomer phase was reduced to 0.03 wt. %.

The solids content was 33 wt. %, the gel content was 1.2 wt. % and the pH was 12.9.

After steam distillation, the dispersion was conditioned in an insulated storage tank for three days, at a temperature of 80° C., wherein the temperature was post-regulated, if required, by an input of heat and the increase in gel content in the latex was measured, using samples.

This dispersion was also creamed as described in Example 1.

B) Substances Used:

| | | | |
|---|---|---|---|
| Polychloroprene | | | Gel: 0%, |
| dispersion from | | | Solids: 58%, |
| Example 1 | | | pH: 12.9 |
| Polychloroprene | | | Gel: 16%, |
| dispersion from | | | Solids: 56%, |
| Example 2 | | | pH: 12.7 |
| Silicon dioxide | DISPERCOLL | Bayer Material | Solids: 50%, |
| dispersion | S 5005 | Science AG | Part. size: 50 nm |
| | | | Surf. area: 50 |
| | | | m²/g |
| Acrylate | PLEXTOL | Polymer Latex | Solids: 60%, |
| dispersion | E 220 | GmbH & Co. KG | Part. size: 630 |
| | | | nm, |
| | | | pH: 2.2 |
| Antioxidant | RHENOFIT | Rhein Chemie | 50% solids in |
| | DDA 50 EM | GmbH | water |
| Zinc oxide | VP 9802 | Borchers GmbH | 50% solids in |
| | | | water |
| Terpene-phenol | HRJ 11112 | Schenectedy | 50% solids in |
| resin | | International, | water |
| dispersion | | Inc. | |

C) Formulations

The following formulations were prepared:

| | Formulation no. | | | | |
|---|---|---|---|---|---|
| | C-1 | C-2 | 3 | 4 | 5 |
| Polychloroprene dispersion (Ex. 1) | 100 | 100 | 100 | — | — |
| Polychloroprene dispersion (Ex. 2) | — | — | — | 100 | 100 |
| DISPERCOLL S 5005 | — | — | 30 | 30 | 30 |
| PLEXTOL E 220 | 30 | — | — | — | — |
| Resin HRJ 11112 | — | 30 | — | — | — |
| RHENOFIT DDA 50 EM | 2 | 2 | 2 | 2 | 2 |
| ZnO (VP 9802) | 4 | 4 | — | — | 4 |

Alkali-resistant VETROTEX glass fiber rovings with a thickness of 2400 Tex were soaked with these formulations and then dried suspended and loaded with a weight in the air in a laboratory.

Specimens prepared in this way were tested for “pull-out” force from a concrete block. The procedure was as follows:

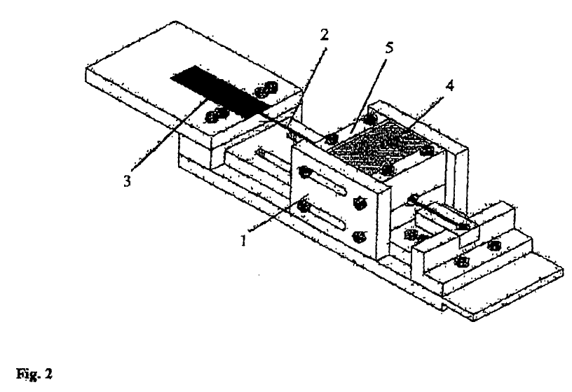

The mold or shell-mold 1 shown in FIG. 2 was used to prepare the specimen for the pull-out test. The fiber 2 was clamped in shell-mold 3. The volume filled with concrete 4 was selected so that the thickness of the pull-out item could be varied by moving a wall 5. All gaps and the ducts in the shell-mold for the roving were sealed with sealants.

The roving was embedded in a concrete block with the base area of 50 mm×50 mm. The thickness of the block could be varied because the bond between the soaked roving and the concrete was chosen to be well below the top.

The concrete formulations were prepared as follows:

| | | | Parts |
|---|---|---|---|
| Feedstock | Type | Supplier | by wt. |
| Binder | | | |
| Cement | CEM 152.5 | Spenner Zement, Erwitle | 490 |
| Additives | | | |
| Fly ash | Safament HKV | Jacob GmbH, Völklingen | 175 |
| Silica dust | EMSAC 500 DOZ | Woermann, Darmstadt | 70 |
| slurry | | | |
| Solvent | FM 40 | Sika Addiment, Leimen | 10.5 |
| Fillers | | | |
| Quartz flour | MILISIL W3 | Quarzwerke Frechen | 499 |
| Sand | 0.2-0.6 mm | Quarzwerke Frechen | 714 |
| Other | | | |
| Water | tap water | STAWAG, Aachen | 245 |

All materials were accurately weighed to 0.1 g and the following mixing procedure followed:
1. cement, fly ash and additives were homogenized (part mixture 1)
2. water, silica slurry and 50% of solvent in this sequence were placed in a mortar mixer (DIN 196-1) (part mixture 2)
3. part mixture 1 carefully added to part mixture 2: mixed for 1.5 min at low speed
4. two minute pause
5. remainder of solvent added and mixed for a further 1.5 min at low speed Removed from mold after 1 day.

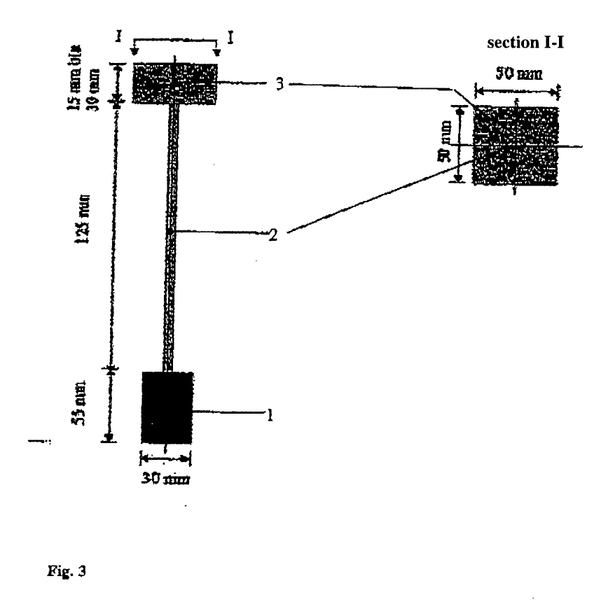

The structure and dimensions of a pull-out specimen and the experimental layout are shown in FIG. 3.

Sample holder 1 was suspended on a cardan joint to keep the effects of any instantaneous or transverse forces small. A rubber support compensated for any slight unevenness on the surface of the concrete block and thus made sure the pressure was distributed more evenly.

The test speed during the trials was 5 mm/min. The rovings 2 were embedded 20 mm into the concrete.

In the “pull-out” trial, the critical force was that at which the roving 2 was released from the concrete matrix 3 and started to slide out.

Force at which the roving started to slide out of the concrete:

| | Formulation no. | | | | |
|---|---|---|---|---|---|
| | C-1 | C-2 | 3 | 4 | 5 |
| Mean value [N] | 75 | 99 | 148 | 177 | 167 |
| Standard deviation [N] | — | 14 | 19 | 29 | 24 |
| Number of samples | 1 | 3 | 5 | 5 | 5 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. In a process for reinforcing one of concrete and cement, the improvement comprising including a fibrous product soaked in a preparation comprising:
(a) about 20 to about 99 wt. % of an aqueous dispersion based on polychloroprene; and
(b) about 1 to about 80 wt. % of an aqueous suspension based on inorganic solids chosen from oxides, carboxides and silicates;
(c) optionally, polymer dispersions chosen from polyacrylates, polyacetates, polyurethanes, polyureas, rubbers and epoxides, and
(d) optionally, additives and auxiliaries chosen from resins, stabilizers, antioxidants, cross-linking agents, cross-linking accelerators, fillers, thickening agents and fungicides,
wherein the weight percentages of (a) and (b) total 100 wt. % and are based on the weight of non-volatile fractions.

2. The process according to claim 1, wherein more than 20 wt. % of the solid in suspension (b) comprises silicon dioxide.

3. The process according to claim 2, wherein the silicon dioxide contains silanol groups.

4. The process according to claim 2, wherein the primary particle size of the silicon dioxide is from about 1 to about 400 nm,

5. The process according to claim 2, wherein the primary particle size of the silicon dioxide is from about 5 to about 100 nm.

6. The process according to claim 2, wherein the primary particle size of the silicon dioxide is from about 8 to about 50 nm.

7. The process according to claim 1, wherein the polychloroprene contains chemically bonded hydroxide groups in about 0.1 to about 1.5% of the polymerized monomer groups.

8. The process according to claim 1, wherein the preparation contains up to about 10 wt. % of zinc oxide.

9. The process according to claim 1, wherein the fibrous product is chosen from fibers, rovings, yarns, textiles, knitted fabrics, bonded fabrics and non-woven fabrics.

10. The process according to claim 1, wherein the preparation comprises about 70 wt. % to about 98 wt. % of polychloroprene dispersion (a) and about 2 wt. % to about 30 wt. % of a dispersion of inorganic solids (b).

11. A fibrous product soaked with a preparation comprising:
(a) about 20 to about 99 wt. % of an aqueous dispersion based on polychloroprene; and
(b) about 1 to about 80 wt. % of an aqueous suspension based on inorganic solids chosen from oxides, carboxides and silicates,
(c) optionally, polymer dispersions chosen from polyacrylates, polyacetates, polyurethanes, polyureas, rubbers and epoxides, and
(d) optionally, additives and auxiliaries chosen from resins, stabilizers, antioxidants, cross-linking agents, cross-linking accelerators, fillers, thickening agents and fungicides,
wherein the weight percentages of (a) and (b) total 100 wt. % and are based on the weight of non-volatile fractions.

12. The fibrous product according to claim 11, wherein more than 20 wt. % of the solid in suspension (b) comprises silicon dioxide.

13. The fibrous product according to claim 12, wherein the silicon dioxide contains silanol groups.

14. The fibrous product according to claim 12, wherein the primary particle size of the silicon dioxide is from about 1 to about 400 nm.

15. The fibrous product according to claim 12, wherein the primary particle size of the silicon dioxide is from about 5 to about 100 nm.

16. The fibrous product according to claim 12, wherein the primary particle size of the silicon dioxide is from about 8 to about 50 nm.

17. The fibrous product according to claim 11, wherein the polychloroprene contains chemically bonded hydroxide groups in about 0.1 to about 1.5% of the polymerized monomer groups.

18. The fibrous product according to claim 11, wherein that the preparation contains up to about 10 wt. % of zinc oxide.

19. The fibrous product according to claim 11 in the form of one of fibers, rovings, yarns, textiles, knitted fabrics, bonded fabrics and non-woven fabrics.

20. The fibrous product according to claim 11, wherein the preparation comprises about 70 wt. % to about 98 wt. % of polychloroprene dispersion (a) and about 2 wt. % to about 30 wt. % of a dispersion of inorganic solids (b).

21. One of reinforced concrete and reinforced cement made by the process according to claim 1.

22. One of a concrete- and cement-based product reinforced with a fibrous product made by the process according to claim 11.
